(19) United States
(12) Patent Application Publication
(10) Pub. No.: US 2009/0104397 A1
(43) Pub. Date: Apr. 23, 2009

(54) Paper Sheet and Paper Sheet Bonding Method

(76) Inventors: Toshio Muranaka, Fujinomiya-shi (JP); Hiroshi Ono, Fujinomiya-shi (JP)

Correspondence Address: QUINN EMANUEL;KODA & ANDROLIA, 865 S. FIGUEROA STREET, 10TH FLOOR, LOS ANGELES, CA, 90017, US

(21) Appl. No.: 11/887,298

(22) PCT Filed: Mar. 29, 2006
(86) PCT No.: PCT/JP2006/306479

§ 371 Date: Apr. 25, 2008

(30) Foreign Application Priority Data
Mar. 21, 2005 (JP) 2005-104718

(51) Int. Cl. B32B 5/12; B29C 65/08

(52) U.S. Cl. 428/113; 156/73.1

(57) ABSTRACT

[PROBLEMS] To bond a paper sheet containing no thermally fusible component with sufficient strength without forming a through hole, deteriorating texture and increasing the material cost.

[MEANS FOR SOLVING PROBLEMS] While pressing a second paper sheet (11) containing no thermally fusible component against a first paper sheet (10) containing no thermally fusible component, an ultrasonic wave is applied to the press contact portion so that fibers of the second paper sheet (11) enter mechanically between fibers of the first paper sheet (10) thus forming a bonding portion without requiring thermal fusion.

### TECHNICAL FIELD

The present invention relates to a paper sheet and paper sheet bonding method.

### BACKGROUND ART

As toilet paper, tissue paper, kitchen paper, paper towel and the like, conventionally, there has been proposed a type of sheet produced by overlaying plural pieces of paper sheets having no thermally fusible component to integrate them in order to improve functionality such as durability, liquid permeation property and absorption property, so that this sheet is available as a single sheet (for example, a type of tissue paper in which two sheets are overlaid is called 2-ply).

As a method of manufacturing such an overlaid sheet, a method of forming fine holes like perforated line on paper sheets overlapped on each other and a method of overlaying paper sheets through adhesive agent or through no adhesive agent and performing no-heat or heat embossing is available (see for example, patent document 1).

However, the method of forming fine holes facilitate permeation of liquid due to existence of the holes penetrating the sheet and deteriorates the texture. The method of overlaying sheets through no adhesive agent and performing embossing has a problem that its bonding strength is weak. Further, the method of overlaying papers through adhesive agent and performing embossing increases material cost by an amount of the adhesive agent. Further, the heat embossing cannot avoid deterioration of the texture by heating. Patent document 1: Japanese Patent Application Laid-Open No.

### DISCLOSURE OF THE INVENTION

### Problem to be Solved by the Invention

Accordingly, a main object of the present invention is to enable the paper sheets to be bonded together with a sufficient strength when bonding the paper sheets having no thermally fusible component, without formation of through holes, deterioration of the texture and increase of material cost.

### Means for Solving the Problem

The present invention which has solved the above-described problem is as follows.

### <Invention According to Claim 1>

A paper sheet in which a second paper sheet having no thermally fusible component is bonded to a first paper sheet having no thermally fusible component,

wherein fibers of the second paper sheet are made to enter mechanically between fibers of the first paper sheet by pressing the second paper sheet against the first paper sheet and applying ultrasonic wave to a pressed portion so as to bond the first and second paper sheets together without thermal fusion.

### (Operation)

If ultrasonic wave is transmitted to a pressed portion with a bonding portion of the paper sheet pressed, fibers of the second paper sheet enter mechanically between fibers of the first paper sheet so that both the sheets can be integrated without thermal fusion. Further, because crystallization of fibers at the bonding portion is accelerated, the bonding portion is supplied with gloss so as to improve the appearance. This principle is considerably different from ultrasonic wave fusion used in other fields than paper art and can achieve a sufficient strength while suppressing deterioration of the texture. Needless to say, formation of through holes or adhesive agent is not needed.

### <Invention According to Claim 2>

The paper sheet according to claim 1 or 2 wherein a bonding portion is arranged in a pattern.

### (Operation)

Although according to the present invention, deterioration of the texture at the bonding portion is small, a change occurs in the texture as compared to a case where nothing is performed. Thus, it is preferable that providing the bonding portion in a pattern shape compensates for the partial change in the texture by entire functionality or functional beauty.

### <Invention According to Claim 3>

The paper sheet according to claim 1 or 2 wherein a degree of gloss 75° at the bonding portion is 1.4 or more times larger than that of a non-bonding portion.

### (Operation)

If the degree of gloss at the bonding portion is in this range, the bonding portion is supplied with beautiful gloss so as to improve the appearance. In the meantime, “the degree of gloss 75°” means a degree of gloss measured by 75° gloss degree test stipulated by JIS P8142 and expresses an amount of reflection light at an output angle of 75° in percentage with respect to an amount of incident light when light is projected to an object portion at an incident angle of 75°.

### <Invention According to Claim 4>

A method of bonding a second paper sheet having no thermally fusible component to a first paper sheet having no thermally fusible component,

the method comprising: pressing the second paper sheet against the first paper sheet and applying ultrasonic wave to a pressed portion so that fibers of the second paper sheet enter mechanically between fibers of the first paper sheet so as to bond the first and second paper sheets together without thermal fusion.

### (Operation)

The same effect as the invention of claim 1 is exerted.

### <Invention According to Claim 5>

The paper sheet according to claim 4 wherein a linear pressure of the pressing is 0.5 to 5.0 kgf/cm, a frequency of the ultrasonic wave is 17 to 100 kHz and an amplitude of the ultrasonic wave is 10 to 100 μm.

### (Operation)

If the linear pressure, frequency and amplitude are in this range when the bonding of the present invention is carried out, it is extremely advantageous.

### EFFECT OF THE INVENTION

As described above, the present invention enables paper sheets having no thermally fusible component to be bonded to each other with a sufficient strength without formation of through holes, deterioration of the texture and increase of material cost.

### BEST MODE FOR CARRYING OUT THE INVENTION

Hereinafter, the embodiment of the present invention will be described with reference to the accompanying drawings.

FIG. 1 shows an example of a paper sheet bonding apparatus 1, which comprises an anvil roll 4 having projecting portions 3, 3, . . . formed in a predetermined pattern on its outer peripheral face and an ultrasonic wave applying portion 2 which makes a pressure contact with the projecting portions 3, 3, . . . of the anvil roll 4. First paper sheet and second paper sheet 10, 11 are passed through between the ultrasonic wave applying portion 2 and the anvil roll 4 while they overlap each other.

The ultrasonic wave applying portion 2 is so constructed that ultrasonic wave vibration generated by the ultrasonic wave vibrator 2A is amplified (amplitude is enlarged) by an amplifying means called booster 2B and transmitted to an object by a means 2C called horn or cone. A drive current corresponding to an operation condition such as amplitude and frequency is supplied to the ultrasonic wave vibrator 2A through an oscillating circuit (not shown). The direction of the ultrasonic wave vibration may be determined appropriately corresponding to the type or installation position of the ultrasonic wave vibrator, as a direction along a plane of the paper sheets 10, 11, that is, a roll width direction and a direction perpendicular to or obliquely-crossed with the roll width direction.

To transmit ultrasonic wave energy to the paper sheets 10, 11 effectively, it is not preferable to use a material which absorbs vibration (such as rubber) for the anvil roll 4.

Although not shown, this apparatus 1 comprises a pressurizing means which pressurizes the horn 2C against the anvil roll 4 and a rotation driving means for the anvil roll 4. As the pressurizing means, a structure of freely pressing the horn 2C to the anvil roll 4 side with a driving source such as an air cylinder may be adopted. As the rotation driving means, a motor or the like may be used and it is preferable to make the rotation speed adjustable in order to adjust a press contact time.

Upon bonding together, the first and second paper sheets 10, 11 are passed through between the ultrasonic wave applying portion 2 (horn 2C thereof) and the anvil roll 4 of the bonding apparatus 1 while the paper sheets overlap each other. The first and second paper sheets 10, 11 are produced using pulp fiber such as NBKP and LBKP by adding softener, paper durability enhancing agent, pigment or the like and does not contain thermally fusible component such as thermally fusible fiber. The first and second paper sheets may be of the same material or of different materials.

The first and second paper sheets 10, 11 placed between the ultrasonic wave applying portion 2 and the anvil roll 4 are partially pressed by the projecting portions 3 of the anvil roll 4 while ultrasonic wave is transmitted to the press contact portion from the ultrasonic wave applying portion 2. Consequently, fibers are vibrated by the ultrasonic wave energy so that fibers of the second paper sheet 11 enter mechanically between the fibers of the first paper sheet 10 and thus, the press contact portions are integrated with each other without thermal fusion so as to form a bonding portion 12. Because the crystallization of fibers is accelerated at the bonding portion 12, the bonding portion is supplied with gloss, thereby providing an excellent appearance.

Preferably, the pressure of the press contact is 0.5 to 5.0 kgf/cm in terms of linear pressure and particularly 2.0 to 3.0 kgf/cm. This press contact pressure may be adjusted with a pressurizing means. If the press contact pressure is too low, bonding is likely to be insufficient, and if the press contact pressure is too high, the paper sheets 10 and 11 may be bored, or the sheet becomes easy to cut at the time of processing, or wearing of the horn or anvil roll is progressed easily, which is not preferable.

Preferably, the press contact speed (length of a sheet bonded per unit time) is 10 to 100 m/minute, particularly 50 to 10 m/minute. The press contact speed may be adjusted by a sheet feeding speed. If the press contact speed is too high, bonding is likely to be insufficient, and if it is too low, productivity drops or a bonding portion 12 is burnt, which is not preferable.

Preferably, the frequency of ultrasonic wave is in a range of 17 to 100 kHz and preferably, the amplitude of ultrasonic wave is in a range of 10 to 100 μm. If the frequency is too low, bonding becomes insufficient unless the press contact time is increased, and if the frequency is too high, processing is progressed excessively unless the press contact time is decreased, which is not preferable. If the amplitude is too low or too high, entering of fibers likely becomes insufficient, so that bonding is likely to be weak.

When the projecting portions 3 of the anvil roll 4 are provided in a pattern shape, the bonding portion 12 is formed corresponding to that pattern. Although this pattern can be determined appropriately, a pattern in which the dot-like bonding portions 12 are arranged in lateral and vertical directions or at random is preferred. The bonding portion 12 may be of any shape, for example, a diamond shape as shown in FIGS. 2 and 3 or an elliptic shape as shown in FIG. 4. A preferred dimensional example of the bonding portion 12 in these cases is 0.8 mm in maximum length a, 0.39 mm M2 in minimum length b and 0.156 mm in area and a preferred application example is 3.1 mm in long pitch A and 1.5 mm in short pitch B.

The bonding portion 12 may adopt a continuous linear pattern such as stripe pattern along a flow direction or a direction perpendicular thereto instead of the dot pattern. Further, the bonding portion 12 may be of picture-like shape as shown in FIG. 5 as well as of geometric pattern.

As another example, the entire surfaces of the sheets 10 and may be formed into the bonding portion instead of providing the bonding portions 12, 12 . . . partially.

### EXAMPLE

A sample of 2-ply (double layers) toilet paper was manufactured by ultrasonic wave bonding of the present invention by adjusting the linear pressure, ultrasonic wave frequency and amplitude, and a degree of gloss and bonding strength of the bonding portion were evaluated. Table 1 shows the result. In the Table, the degree of gloss of the bonding portion is a relative value when the degree of gloss of a non-bonding portion is assumed to be 100. As regards the bonding strength, “weak” means a bonding strength of an extent which allows sheets to be separated easily in a continuous usage process as toilet paper, and “strong” means a bonding strength of an extent which inhibits the sheets from being separated in a continuous usage process as toilet paper.

TABLE 1

| | Linear | | | | |
|---|---|---|---|---|---|
| | pressure | Frequency | Amplitude | Degree of | Bonding |
| | (kgf/cm) | (kHz) | (μm) | gloss | strength |
| Example 1 | 2 | 50 | 50 | 181 | strong |
| Example 2 | 5 | 100 | 100 | 198 | strong |
| Example 3 | 10 | 100 | 100 | 199 | strong |
| Example 4 | 5 | 150 | 100 | 192 | strong |
| Example 5 | 5 | 100 | 150 | 195 | strong |
| Example 6 | 0.1 | 50 | 50 | 103 | weak |
| Example 7 | 2 | 10 | 50 | 101 | weak |
| Example 8 | 2 | 50 | 5 | 105 | weak |

### INDUSTRIAL APPLICABILITY

The present invention can be applied to application for bonding plural pieces (not limited to two pieces) of papers as typified by toilet paper, tissue paper, kitchen paper, paper towel and the like.

### BRIEF DESCRIPTION OF THE DRAWINGS

FIG. 1 is a schematic diagram of a bonding apparatus.

FIG. 2 is a plan view showing an example of a bonding pattern.

FIG. 3 is a sectional view taken along III-III of FIG. 2.

FIG. 4 is a plan view showing an example of a bonding pattern.

FIG. 5 is a plan view showing an example of a bonding pattern.

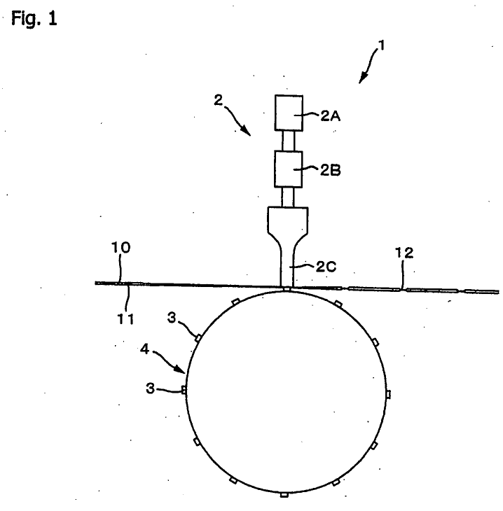

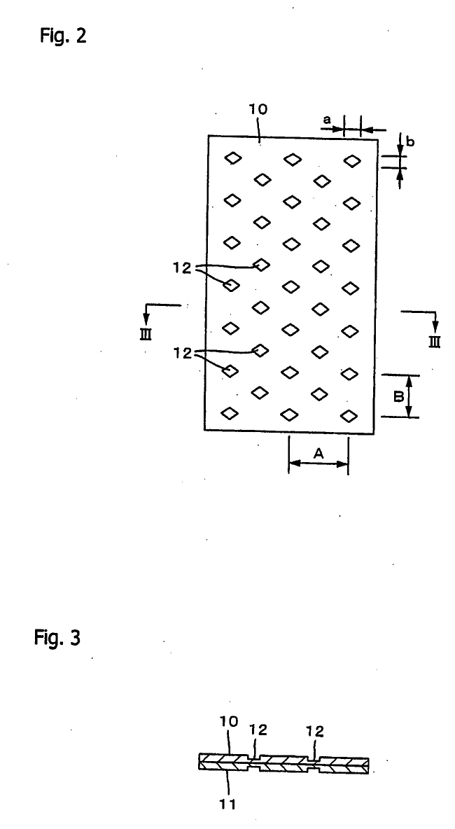

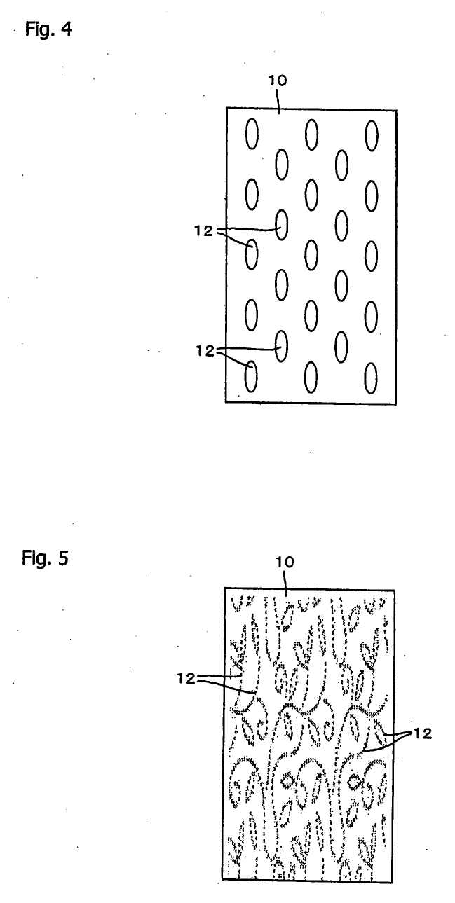

### DESCRIPTION OF REFERENCE NUMERALS

1: bonding apparatus, 2: ultrasonic wave applying portion, 3: projecting portion, 4: anvil roll, 10: first paper sheet, 11: second paper sheet, 12: bonding portion

1. A paper sheet in which a second paper sheet having no thermally fusible component is bonded to a first paper sheet having no thermally fusible component,
wherein fibers of the second paper sheet are made to enter mechanically between fibers of the first paper sheet by pressing the second paper sheet against the first paper sheet and applying ultrasonic wave to a pressed portion so as to bond the first and second paper sheets together without thermal fusion.

2. The paper sheet according to claim 1 or 2 wherein a bonding portion is arranged in a pattern.

3. The paper sheet according to claim 1 or 2 wherein a degree of gloss 750 (JIS P8142) at the bonding portion is 1.4 or more times larger than that of a non-bonding portion.

4. A method of bonding a second paper sheet having no thermally fusible component to a first paper sheet having no thermally fusible component,
the method comprising: pressing the second paper sheet against the first paper sheet and applying ultrasonic wave to a pressed portion so that fibers of the second paper sheet enter mechanically between fibers of the first paper sheet so as to bond the first and second paper sheets together without thermal fusion.

5. The paper sheet according to claim 4 wherein a linear pressure of the pressing is 0.5 to 5.0 kgf/cm, a frequency of the ultrasonic wave is 17 to 100 kHz and an amplitude of the ultrasonic wave is 10 to 100 μm.
